(19) United States
(12) Patent Application Publication
(10) Pub. No.: US 2006/0016879 A1
(43) Pub. Date: Jan. 26, 2006

(54) Presentation instrument security arrangement and methods

(75) Inventor: Brian Thomas Kean, Missouri Valley, IA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/900,011

(22) Filed: Jul. 26, 2004

(51) Int. Cl. G06K 5/00; G07F 19/00; G06K 19/06

(52) U.S. Cl. 235/380; 235/379; 235/492; 235/493

(57) ABSTRACT

A presentation instrument includes a first information encoding region and a second information encoding region. The first information encoding region has a unique characteristic. The first information encoding region stores an account identifier. The second information encoding region has a first security value stored thereon. The first security value relates to the unique characteristic of the first information encoding region.

### CROSS-REFERENCES TO RELATED APPLICATIONS

This application is related to the following commonly-assigned U.S. patent applications: Provisional U.S. Patent Application Ser. No. 60/147,899, entitled, “INTEGRATED POINT OF SALE DEVICE” (Attorney Docket No. 020375-002400US), filed on Aug. 9, 1999, by Randy Templeton, et al.; U.S. patent application Ser. No. 09/634,901 (now U.S. Pat. No. 6,547,132), entitled, “POINT OF SALE PAYMENT TERMINAL” (Attorney Docket No. 020375-002410US), filed on Aug. 9, 2000, by Randy Templeton, et al.; co-pending U.S. patent application Ser. No. 10/116,689, entitled, “SYSTEMS AND METHODS FOR PERFORMING TRANSACTIONS AT A POINT-OF-SALE DEVICE” (Attorney Docket No. 020375-002411US), filed on Apr. 3, 2002, by Earney Stoutenburg, et al.; co-pending U.S. patent application Ser. No. 10/116,733, entitled, “SYSTEMS AND METHODS FOR DEPLOYING A POINT-OF-SALE SYSTEM” (Attorney Docket No. 020375-002412US), filed on Apr. 3, 2002, by Earney Stoutenburg, et al.; co-pending U.S. patent application Ser. No. 10/116,686, entitled, “SYSTEMS AND METHODS FOR UTILIZING A POINT-OF-SALE SYSTEM” (Attorney Docket No. 020375-002413US), filed on Apr. 3, 2002, by Earney Stoutenburg, et al.; co-pending U.S. patent application Ser. No. 10/116,735, entitled, “SYSTEMS AND METHODS FOR CONFIGURING A POINT-OF-SALE SYSTEM” (Attorney Docket No. 020375-002414US), filed on Apr. 3, 2002, by Earney Stoutenburg; co-pending U.S. patent application Ser. No. 10/225,410, entitled, “MULTI-PURPOSE KIOSK AND METHODS” (Attorney Docket No. 020375-024800US), filed on Aug. 20, 2002, by Paul Blair, et al.; co-pending U.S. patent application Ser. No. 10/741,586, entitled, “CARD READING SYSTEMS AND METHODS” (Attorney Docket No. 020375-043900US), filed on Dec. 19, 2003, by Timothy Walpus, et al.; and co-pending U.S. patent application Ser. No. 10/460,741, entitled, “VALUE PROCESSING NETWORK AND METHODS” (Attorney Docket No. 020375-027310US), filed on Jun. 11, 2003, by George Nauman, et al., the entire disclosure of each of which are herein incorporated by reference in their entirety for all purposes.

### BACKGROUND OF THE INVENTION

The present invention relates generally to presentation instruments. This application relates more specifically to security arrangements for presentation instruments.

Credit card fraud is a significant problem. Fraudulent transactions involving presentation instruments (e.g., credit cards, gift cards, and the like) increase the cost of such transactions, thus harming merchants, consumers, card issuers, and the vendors that provide card production and transaction settlement services.

Some presentation instruments encode account identifiers on magnetic stripes on the cards. Account identifiers, however, may be “skimmed” by various means and stored on other cards having magnetic stripes, thus allowing thieves to illegally use the accounts without possessing the actual presentation instrument.

Some have tried to combat this by using magnetic fingerprint technology, also known as MAGNEPRINT™ technology. In short, this technology allows the unique magnetic signature, or fingerprint, of a magnetic stripe to be determined and stored as a numeric value. The technology is described more fully in U.S. Pat. No. 5,365,586, which patent is incorporated herein by reference in its entirety for all purposes. Thus, when a purchaser presents a card having a magnetic stripe to settle a transaction, the account identifier is read from the magnetic stripe and the magnetic fingerprint of the magnetic stripe is sensed. Both are then sent to a host computer system to authorize a transaction. If the sensed magnetic fingerprint does not match one stored at the host computer system relating to the account, the transaction is denied. This process, however, significantly increases the time and computing resources required to approve a transaction. Thus, other solutions are needed.

### BRIEF SUMMARY OF THE INVENTION

Embodiments of the invention thus provide a presentation instrument. The presentation instrument includes a first information encoding region and a second information encoding region. The first information encoding region has a unique characteristic. The first information encoding region stores an account identifier. The second information encoding region has a first security value stored thereon. The first security value relates to the unique characteristic of the first information encoding region.

The presentation instrument may be a credit card, debit card, gift card, smart card, RF-enabled card, fob, a negotiable instrument having magnetic ink character recognition-enabled printing, three-dimensional object or the like. The first and second information encoding regions may be the same region. The first and second information encoding regions may be different regions. The first information encoding region may be a magnetic encoding region and the unique characteristic may be a magnetic fingerprint. The second information encoding region may be a RF-enabled device. The second information encoding region may be a bar code. The first security value may be an alphanumerical representation of the unique characteristic. The first security value may be a pass threshold value relating to an alphanumerical representation of the unique characteristic. The first security value may be a digital signature produced at least in part from an alphanumerical representation of the unique characteristic. The first security value may be the magnetic fingerprint, a key identifier, a pass threshold value, a key check value, at least a portion of an account identifier, and/or the like. The second security value may be a digital signature encrypted using an elliptic key from a hash of the first security value. The second security value may be a digital signature determined using the magnetic fingerprint, the pass threshold value, the key identifier, at least a portion of a magnetic stripe image, and/or the like. The second information encoding region also may have a second security value stored thereon. The second security value may relate to the unique characteristic of the first information encoding region. The first information encoding region may include a magnetic encoding region, the second information encoding region may include a RF-enabled device, the first security value may be an alphanumerical representation of the magnetic fingerprint of the magnetic encoding region, and the second security value may be a digital signature produced at least in part from the alphanumerical representation of the magnetic fingerprint. The first information encoding region may include a magnetic encoding region, the second information encoding region may include a bar code, the unique characteristic may include a magnetic fingerprint, and the first security value may include an alphanumerical representation of the magnetic fingerprint.

Other embodiments include a method of settling a transaction using a presentation instrument. The method includes at a point of sale device, reading an account identifier from a first information encoding region of the presentation instrument, sensing a unique characteristic of the first information encoding region, reading a first security value from a second information encoding region, and comparing a representation of the sensed unique characteristic to a representation of the first value. The security value may relate to the unique characteristic. The method also may include approving the transaction based at least in part on the comparison. The method may include sending an authorization request to a host computer system, receiving a response, and based at least in part on the response, completing the transaction.

In some embodiments, a method of encoding a presentation instrument includes sensing a unique characteristic of a first information encoding region of the presentation instrument, storing an account identifier relating to the presentation instrument on the first information encoding region, determining a first security value using the unique characteristic, and storing the first security value on a second information encoding region. The method may include determining a second security value relating to the unique characteristic of the first information encoding region and storing the second security value on the second information encoding region

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 illustrates a transaction processing system according to embodiments of the invention.

FIG. 2 illustrates a presentation instrument having a security arrangement according to embodiments of the invention.

FIG. 3 illustrates a method of producing a presentation instrument according to embodiments of the invention.

FIG. 4 illustrates a method of settling a transaction using a presentation instrument according to embodiments of the invention.

### DETAILED DESCRIPTION OF THE INVENTION

Embodiments of the present invention relate to presentation instrument security. Herein, a presentation instrument may be any instrument that could be used to settle a transaction. Examples include credit cards, gift cards, debit cards, smart cards, and the like. Presentation instruments could also comprise negotiable instruments, such as checks, having magnetic ink characters (e.g., MICR characters). In some embodiments described herein, presentation instruments have at least two information encoding regions. Information encoding regions include magnetic regions—such as magnetic stripes—bar codes, smart chips, radio frequency (RF)-enabled cards, and the like. In a specific embodiment, at least one of the information encoding regions comprises a magnetic stripe. In some embodiments described herein, one of the information encoding regions has a unique characteristic that may be expressed quantitatively. In a specific embodiment wherein the information encoding region comprises a magnetic stripe, the unique characteristic comprises the magnetic stripe's “magnetic fingerprint,” “digital fingerprint,” or simply “fingerprint.”

A magnetic stripe's fingerprint, in some embodiments, is a numerical or alphanumerical representation of the background magnetic particulate distribution of a magnetic stripe on a typical presentation instrument. Some skilled in the art refer to a specific type of a magnetic stripe's digital fingerprint as a “MAGNEPRINT™,” which comprises a 54-byte value representing the particulate distribution. Devices employing the technology are available from Magtek, Inc., of Carson, Calif. The present invention, however, is not limited to the MAGNEPRINT™ technology.

According to embodiments of the present invention, a presentation instrument's primary information encoding region stores an identifier, such as an account identifier, relating to the presentation instrument. The primary information encoding region has a unique characteristic that may be quantitatively expressed. A security value relating to the unique characteristic is also stored on the presentation instrument.

The security value relating to the unique characteristic may be stored in the primary information encoding region and/or in a secondary information encoding region. The security value may be the unique characteristic itself, a numerical or alphanumerical representation of it, or some other value relating to the unique characteristic. In some embodiments, the security value is a combination of items. In other embodiments, the security value is a digital signature produced using the unique characteristic, a “hash” of the unique characteristic, or other number relating to the unique characteristic. In some embodiments, multiple security values relating to the unique characteristic may be stored on the presentation instrument.

In a specific embodiment, the presentation instrument comprises a credit card having a magnetic stripe and a RF-enabled device. The magnetic stripe stores the account identifier relating to the credit card. The RF-enabled device stores the magnetic fingerprint of the magnetic stripe, a pass threshold value to be used during transaction authorization, a key identifier, and a digital signature. The digital signature is produced by determining a hash value of the magnetic fingerprint, the pass threshold value, and the key identifier, then encrypting the hash value using a private key. In another specific embodiment, the presentation instrument comprises a gift card having a magnetic stripe and a bar code, which may be, for example, one-dimensional or two-dimensional. The magnetic stripe stores an account identifier relating to the gift card. The bar code stores the fingerprint of the magnetic stripe, the pass threshold value, the key identifier, and the digital signature. Many other embodiments are possible.

According to some embodiments of the invention, a customer tenders a presentation instrument to settle a transaction. The merchant, which may be a retailer, a service provider, or the like, engages the presentation instrument to a reader, which may be a point-of-sale device. The reader reads the account identifier from the primary information encoding region. The reader also senses the unique characteristic of the primary information encoding region. The reader also reads the security value relating to the unique characteristic, which may be stored on the primary information encoding region or other information encoding region. If the security value is the unique characteristic itself, the reader compares the security value to the sensed unique characteristic. If the security value included a pass threshold value, the device uses the threshold value to determine if the comparison is acceptable. If the security value includes a digital signature, the reader decrypts the digital signature, which may be facilitated by the use of the key identifier to determine which of several keys should be used to decrypt the signature. If the signature includes a hash of the unique characteristic, key identifier, and/or threshold value, then the device hashes the appropriate values and compares it to the decrypted signature. Of course, if multiple security values are stored, the reader may perform multiple comparisons.

In some embodiments of the invention, the comparisons are not performed every time a presentation instrument is used. As part of a transaction approval process, a host computer system to which an approval request is directed may determine when the reader should perform the comparison or comparisons. In some embodiments, a counter stored on the presentation instrument itself may increment with each use and signal a comparison upon reaching a predetermined threshold. Other examples are possible. In a specific embodiment, a presentation includes a magnetic stripe and a RF device. The RF device stores the security value or values as well as an account identifier. The RF device also includes a transaction counter and/or a threshold trigger. The presentation instrument may be used to settle a transaction using only the RF device without having to read the account information from the magnetic stripe. If, however, the transaction counter reaches a predetermined value and/or the transaction value exceeds a threshold trigger, the point-of-sale device may signal the need to run the presentation instrument through a reader so that the magnetic fingerprint may be sensed and used in the transaction authorization. Otherwise, the transaction may be approved without security authorization.

In embodiments having a digital signature, any of a number of well known cryptographic technologies may be used to encrypt and decrypt the unique characteristic and the security value stored on the presentation instrument. In some embodiments, RSA-based digital certificates may be used. In other embodiments, elliptic key cryptography (EC) is used. Many other examples are possible.

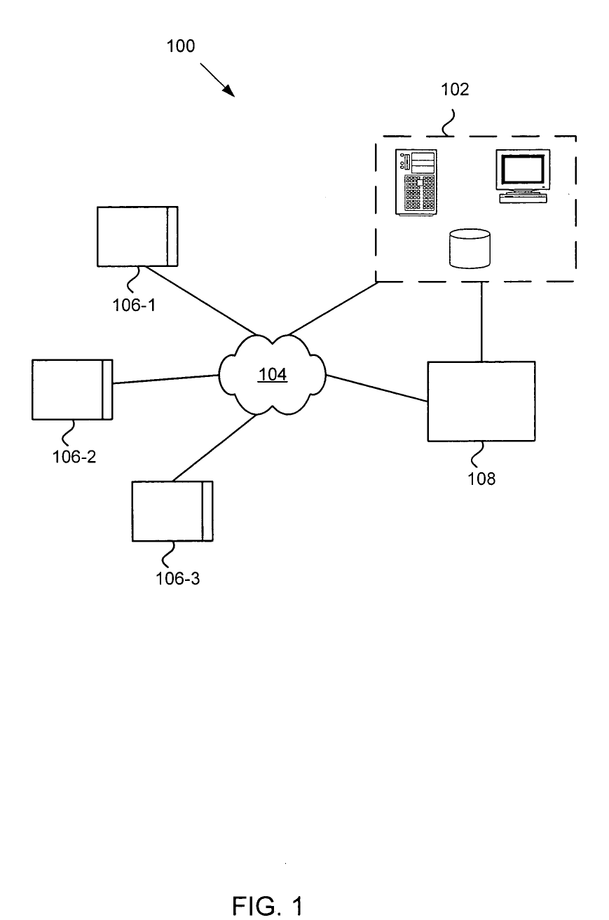

Having described embodiments of the present invention generally, attention is directed to FIG. 1, which illustrates a system 100 according to some embodiments. It is to be understood that the system 100 is merely exemplary of myriad possible system embodiments according to the present invention. Those skilled in the art will appreciate many other embodiments.

The system 100 includes a host computer system 102, a network 104, and a plurality of point-of-sale devices 106. The host computer system 102 may include, for example, server computers, personal computers, workstations, web servers, and/or other suitable computing devices. The host computer system 102 includes application software that programs the host computer system 102 to perform one or more functions according to the present invention. For example, application software resident on the host computer system 102 may program the host computer system 102 to settle transactions involving presentation instruments having security arrangements according to embodiments of the invention. The host computer system 102 may include one or more of the aforementioned computing devices, as well as storage devices such as databases, disk drives, optical drives, and the like. The storage devices may include solid state memory, such as RAM, ROM, PROM, and the like, magnetic memory, such as disc drives, tape storage, and the like, and/or optical memory, such as DVD. The host computer system 102 may be fully located within a single facility or distributed geographically, in which case a network may be used to integrate the host computer system 102. Many other examples are possible and apparent to those skilled in the art in light of this disclosure.

The network 104 may be the Internet, an intranet, a wide area network (WAN), a local area network (LAN), a virtual private network, any combination of the foregoing, or the like. The network 104 may include both wired and wireless connections, including optical links. In some embodiments, the network 104 is a transaction processing network.

The point-of-sale devices (POS) 106 may be any of a variety of POS types, some of which are more fully described in previously-incorporated U.S. Pat. No. 6,547,132. Essentially, POS devices are terminals for receiving transaction information and sending the information to a host computer system. For example, a POS may receive transaction information by capturing it from a card using a reader integral to or associated with the POS. A POS also may receive information from an attendant or customer via a keypad, keyboard, bar code reader, Portable Data File (PDF) reader, RF transceiver, and/or other input device. Other examples are possible. POS devices are typically located at merchant locations that accept presentation instruments to settle transactions. POS devices also may be unmanned devices such as kiosks, automated teller machines, and the like.

Each POS 106 includes at least one reader portion configured to read security values and account identifiers from presentation instruments. In some embodiments, a POS 106-1 includes a RF reader for reading information from a RF-enabled presentation instrument. A POS 106-2 includes a bar code reader for reading a bar code on a presentation instrument. A POS 106-3 includes a magnetic stripe reader for reading a magnetic stripe. Any or all of the POS 106 may have multiple readers, which may be the aforementioned readers or other readers.

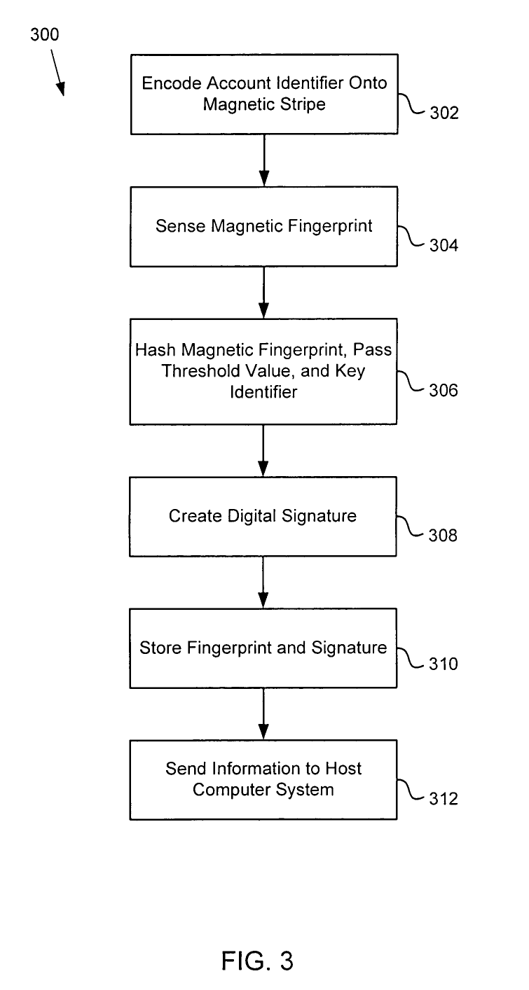

The system 100 also includes presentation instrument production equipment 108. As will be described in more detail with respect to FIG. 3, the presentation instrument production equipment 108 produces presentation instruments having a security arrangement according to embodiments of the invention. The presentation instrument production equipment 108 may be in communication with the host computer system 102 either directly or via the network 104. As such, the presentation instrument production equipment 108 may transmit information to a storage arrangement associated with the host computer system 102. In some embodiments, the presentation instrument production equipment 108 is part of the host computer system.

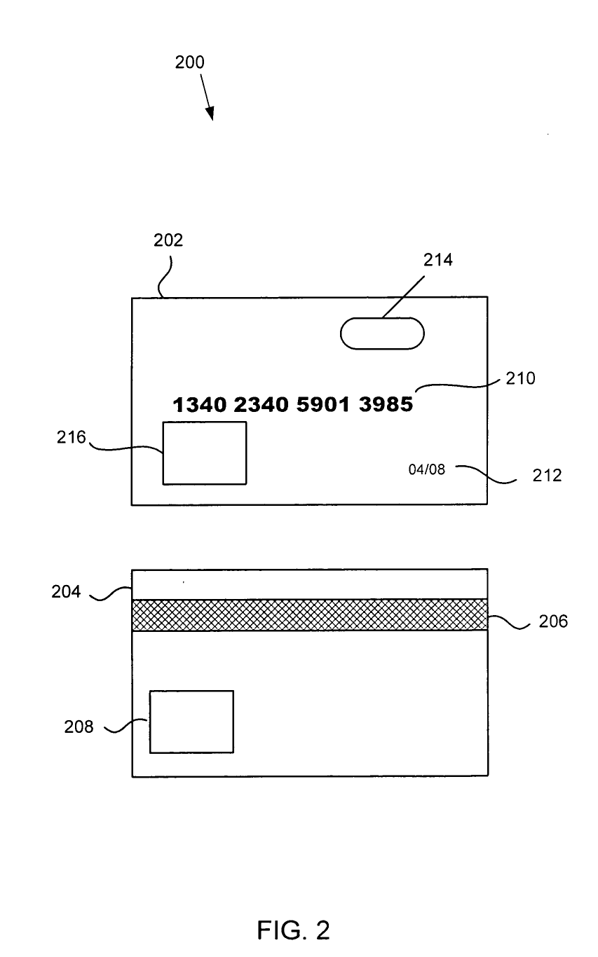

Having described a system according to embodiments of the invention, attention is directed to FIG. 2, which illustrates a presentation instrument 200 according to embodiments of the invention. It is to be understood that the presentation instrument 200 is merely exemplary. Many other examples are possible according to embodiments of the present invention. The presentation instrument 200 may be any of the aforementioned presentation instruments.

The presentation instrument 200 has a front side 202 and a back side 204. In this specific embodiment, the presentation instrument 200 is a credit card having a magnetic stripe 206 and an RF-enabled device 208 as information encoding regions. Other embodiments may have only one information encoding region. Still other embodiments may have greater than two information encoding regions. Still other embodiments may have different information encoding regions, such as a bar code, or the like. It is to be understood that the term “bar code” is used to refer to all types of bar codes, including one-dimensional bar codes and two-dimensional bar codes (sometimes referred to as Portable Data Files, or PDFs, an example of which is PDF-417). The presentation instrument 200 also includes an embossed account number 210 and expiration date 212 and may include a brand 214 and/or hologram 216.

In this specific embodiment, the magnetic stripe 206 comprises a primary information encoding region. The magnetic stripe 206 is used to store the account identifier relating to the presentation instrument 200 and is capable of being read by a POS, such as the POS 106-3 of FIG. 2. As is known, the magnetic stripe may have a number of tracks and may store other account-related and security information, such as, for example, expiration date, CVV values, and the like, which may be secure or non-secure, any or all of which may be referred to herein as Magnetic Stripe Image information, or simply MSI information. The magnetic stripe 206 also has a unique characteristic, which in this specific embodiment is a magnetic fingerprint as previously described. The POS 106-3 also is capable of sensing the unique characteristic from the magnetic stripe 206. In this specific embodiment, the RF-enabled device 208 comprises a secondary information encoding region. This RF-enabled device 208 stores one or more values representing the unique characteristic of the primary information encoding region. In other embodiments, the one or more values may be stored on the primary information encoding region.

The one or more security values representing the unique characteristic of the primary information encoding region may include a quantitative representation of the unique characteristic, a threshold pass value, a key identifier, a key check value, account and/or card expiration information, any image or other information from the primary information encoding region or any portion thereof, a digital signature produced using the quantitative representation, and/or the like. The first security value also may include an indicator as to whether the card may be used for “contactless” transactions (i.e., transactions in which the card is not physically engaged to a transaction terminal. Any or all of the one or more security values may be encrypted using any of a variety of cryptographic technologies, including RSA encryption, elliptic key encryption, or the like. Many other examples are possible.

Having described a presentation instrument 200 according to embodiments of the invention, attention is directed to FIG. 3, which illustrates a method 300 of producing such a presentation instrument according to embodiments of the invention. The method 300 may be implemented in the presentation instrument production equipment 108 of FIG. 1 or other suitable system. It is to be understood that the method 300 is merely exemplary; other methods of producing presentation instruments according to embodiments of the invention may include more, fewer, or different steps. Further, the steps described herein may be traversed in orders other than that described herein. These other examples are apparent to those skilled in the art.

In this specific embodiment, the presentation instrument being produced is a credit card having a magnetic stripe as a primary information encoding region and an RF-enabled device as a secondary information encoding region. The magnetic stripe is used to store an account identifier relating to the presentation instrument, among other things, and the RF-enabled device is used to store two security values. The first security value includes four items: a numerical representation of the magnetic fingerprint, a pass threshold value, a key identifier, and a key check value. The second security value comprises a digital fingerprint produced by first creating a hash value of the items in the first security value, together with the last four digits of an account number and a four digit representation of the card's expiration date in the form YYMM. The hash value is then encrypted using a private key and EC technology. Optionally, some or all of the MSI information also may be encrypted along with the hash value. In other embodiments, the presentation instrument may be a gift card, and the secondary information encoding region may be a bar code. Many other examples are possible.

The pass threshold value may be determined by a card issuer and represents the minimum require match between the stored magnetic fingerprint and one sensed by a POS during transaction authorization. The key identifier determines which of several public keys must be used to decrypt the digital signature. The key check value is used to verify that the correct keys are loaded in a transaction terminal being used to settle a transaction using the card.

In place of the account number and expiration date, the first or second security value may include complete account information (e.g., the entire content of the magnetic stripe or any portion thereof). For example, non-sensitive MSI information may be included in an unencrypted portion of a security value and/or sensitive MSI information may be included in an encrypted portion of a security value. This would allow a contactless transaction since the account number information would not need to be read from the magnetic stripe. In such embodiments, the credit card or gift card may include an indicator that lets a contactless transaction terminal know whether the card qualifies for contactless transaction settlement. The indicator could be binary, in which case the card could either be used for contactless transactions or not. In other embodiments, the indicator may have more than two values, which could be used to indicate the frequency with which contactless transactions could be allowed before triggering a read of the magnetic fingerprint. Those skilled in the art will appreciate how the foregoing items may be included on the card in light of the disclosure that follows immediately hereinafter.

The method begins at block 302. At this location, the account identifier is encoded onto the magnetic stripe. At block 304, the magnetic fingerprint of the magnetic stripe is sensed from the presentation instrument. The magnetic fingerprint, pass threshold value, and key identifier are hashed at block 306 to produce a hash value. The hash value may be produced using any of a number of well known hashing algorithms. At block 308, the hash value is encrypted using an EC private key to produce a digital signature. At block 310, the magnetic fingerprint and the digital signature are stored on the RF-enabled device. At block 312, relevant information is sent to the host computer system for storage. The relevant information may include the account identifier, the magnetic fingerprint, the private key, the digital signature, and/or the like. Other elements of personalization may include encoding of the key check value in the first security value, and/or inclusion of some or all of the MSI information in the first or second security values.

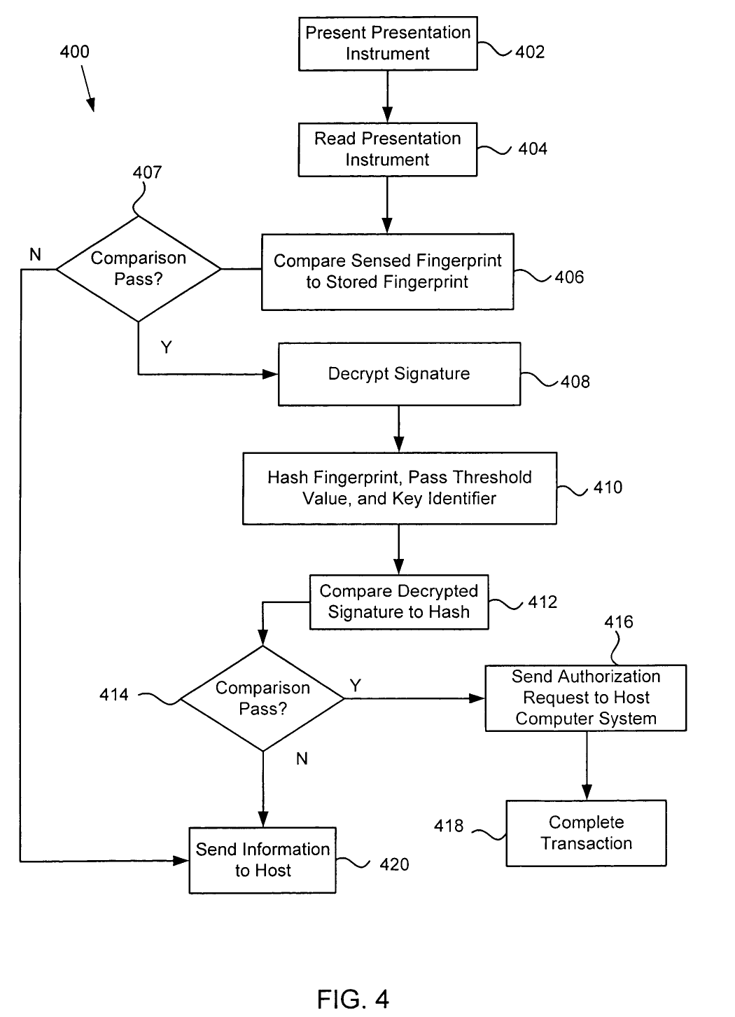

Attention is directed to FIG. 4, which illustrates a method 400 of using a presentation instrument, such as those described herein, to settle a transaction according to embodiments of the invention. The method 400 may be implemented in the system 100 of FIG. 1 or other suitable system. As with the previous method 300, the method 400 is merely exemplary, and other such methods may include more, fewer, or different steps. Further, other methods according to embodiments of the invention may traverse the steps described herein in different orders.

In this specific example of a method according to embodiments of the invention, the presentation instrument comprises the credit card 200 described previously with respect to FIG. 2. Other methods according to embodiments of the invention may use different presentation instruments.

The method 400 begins at block 402, wherein a cardholder presents the presentation instrument to settle a transaction. A merchant or the cardholder engages the presentation instrument to a reader of a POS at block 404. The POS may be one of the POS devices described previously with respect to FIG. 1. The POS includes a magnetic stripe reader, a magnetic fingerprint reader, and a RF reader. The POS reads the account identifier from the magnetic stripe. The POS also senses the magnetic fingerprint of the magnetic stripe. The POS also reads two security values from the RF-enabled device of the presentation instrument. The first security value includes the magnetic fingerprint (e.g., a numerical representation of the magnetic fingerprint), a pass threshold value, and a key identifier. The second security value comprises a digital signature produced from a hash of the first security value.

At block 406, the POS compares the sensed magnetic fingerprint to the stored magnetic fingerprint. At block 407, if the degree of match exceeds the pass threshold value, then the comparison is acceptable and the process continues at block 408. Otherwise, the process continues at block 420, which will be described hereinafter.

At block 408, the digital signature is decrypted. This comprises using the key identifier to select a public key and using the key to decrypt the fingerprint. Since the digital signature was produced by hashing the fingerprint, pass threshold value, and key identifier, the decrypted signature should produce the hash. At block 410, the stored fingerprint, pass threshold value and key identifier are hashed to create a hash value. At block 412, the hash value is compared to the decrypted signature. At block 414, if the decrypted signature matches the hash value, then the process continues at block 416. Otherwise the process continues at block 420. At block 416, an authorization request is sent to the host computer system, and the process is completed at block 418 if the host authorizes the transaction. Sending the request at block 416 may include sending comparison results relating to the security authorization to the host. At block 420, information relating to failed comparisons is sent to the host computer system. This may include using a key check value to inform the host computer system that the terminal did not have the correct public key to complete the authorization.

The foregoing method may include incrementing a counter, either at the host computer system or on the presentation instrument itself, and only performing the comparisons if the counter reaches a pre-determined index. Further, any or all of the comparisons may employ “fuzzy logic” to determine a comparison to be successful even in cases wherein a comparison does not produce a 100% match.

It is to be understood that alternative methods according to embodiments of the invention may not follow this exact process. For example, the authorization request may be sent to the host while the POS process the security comparisons. Those skilled in the art will appreciate many other possible equivalents.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to arrange computers into a network and enable communication among the computers. Additionally, those skilled in the art will realize that the present invention is not limited to magnetic fingerprint technology. For example, the present invention may be used exploit unique RF signatures, optical properties, or other unique characteristics of information encoding regions. Further still, the present invention is not limited to magnetic fingerprints on presentation instruments. The present invention also relates to magnetic fingerprints on magnetic ink characters (e.g., Magnetic Ink Character Recognition “MICR” technology) on other instruments, such as negotiable instruments. Accordingly, the above description should not be taken as limiting the scope of the invention,

What is claimed is:

1. A presentation instrument, comprising:
a first information encoding region, wherein the first information encoding region has a unique characteristic, the first information encoding region having stored thereon an account identifier;
a second information encoding region having a first security value stored thereon, wherein the first security value relates to the unique characteristic of the first information encoding region.

2. The presentation instrument of claim 1, wherein the presentation instrument comprises a selection from the group consisting of credit card, debit card, gift card, smart card, RF-enabled card, fob, a negotiable instrument having magnetic ink character recognition-enabled printing, and three-dimensional object.

3. The presentation instrument of claim 1, wherein the first and second information encoding regions comprise the same region.

4. The presentation instrument of claim 1, wherein the first and second information encoding regions comprise different regions.

5. The presentation instrument of claim 1, wherein the first information encoding region comprises a magnetic encoding region and the unique characteristic comprises a magnetic fingerprint.

6. The presentation instrument of claim 1, wherein the second information encoding region comprises a RF-enabled device.

7. The presentation instrument of claim 1, wherein the second information encoding region comprises a bar code.

8. The presentation instrument of claim 1, wherein the first security value comprises an alphanumerical representation of the unique characteristic.

9. The presentation instrument of claim 1, wherein the first security value comprises a pass threshold value relating to an alphanumerical representation of the unique characteristic.

10. The presentation instrument of claim 1, wherein the first security value comprises a digital signature produced at least in part from an alphanumerical representation of the unique characteristic.

11. The presentation instrument of claim 1, wherein the first security value comprises a selection from the group consisting of the magnetic fingerprint, a key identifier, a pass threshold value, a key check value and at least a portion of an account identifier.

12. The presentation instrument of claim 11, wherein the second security value comprises a digital signature, encrypted using an elliptic key from a hash of the first security value.

13. The presentation instrument of claim 11, wherein the second security value comprises a digital signature determined using one or more selections from the group consisting of the magnetic fingerprint, the pass threshold value, the key identifier, and at least a portion of a magnetic stripe image.

14. The presentation instrument of claim 1, wherein the second information encoding region also has a second security value stored thereon, wherein the second security value relates to the unique characteristic of the first information encoding region.

15. The presentation instrument of claim 14, wherein the first information encoding region comprises a magnetic encoding region, the second information encoding region comprises a RF-enabled device, the first security value comprises an alphanumerical representation of the magnetic fingerprint of the magnetic encoding region, and the second security value comprises a digital signature produced at least in part from the alphanumerical representation of the magnetic fingerprint.

16. The presentation instrument of claim 1, wherein the first information encoding region comprises a magnetic encoding region, the second information encoding region comprises a bar code, the unique characteristic comprises a magnetic fingerprint, and the first security value comprises an alphanumerical representation of the magnetic fingerprint.

17. A method of settling a transaction using a presentation instrument, the method comprising:
at a point of sale device, reading an account identifier from a first information encoding region of the presentation instrument;
at the point-of-sale device, sensing a unique characteristic of the first information encoding region;
at the point of sale device, reading a first security value from a second information encoding region, wherein the security value relates to the unique characteristic;
at the point-of-sale device, comparing a representation of the sensed unique characteristic to a representation of the first value; and
approving the transaction based at least in part on the comparison.

18. The method of claim 17, wherein the presentation instrument comprises a selection from the group consisting of credit card, debit card, gift card, smart card, RF-enabled card, fob, a negotiable instrument having magnetic ink character recognition-enabled printing, and three-dimensional object.

19. The method of claim 17, wherein the first and second information encoding regions comprise the same region.

20. The method of claim 17, wherein the first and second information encoding regions comprise different regions.

21. The method of claim 17, wherein the first information encoding region comprises a magnetic encoding region and the unique characteristic comprises an alphanumerical representation of a magnetic fingerprint of the magnetic encoding region.

22. The method of claim 17, wherein the second information encoding region comprises a RF-enabled device.

23. The method of claim 17, wherein the second information encoding region comprises a bar code.

24. The method of claim 17, wherein the first security value comprises an alphanumerical representation of the unique characteristic.

25. The method of claim 17, wherein the first security value comprises a digital signature relating to an alphanumerical representation of the unique characteristic.

26. The method of claim 17, wherein the first security value comprises a digital signature produced at least in part from the alphanumerical representation of the unique characteristic.

27. The method of claim 17, further comprising:
sending an authorization request to a host computer system;
receiving a response; and
based at least in part on the response, completing the transaction.

28. A presentation instrument, comprising:
first means for encoding information, wherein the first means has a unique characteristic, the first means having stored thereon an account identifier;
second means for encoding information, wherein the second means has a first security value stored thereon, wherein the first security value relates to the unique characteristic of the first means.

29. A method of encoding a presentation instrument, comprising:
sensing a unique characteristic of a first information encoding region of the presentation instrument;
storing an account identifier relating to the presentation instrument on the first information encoding region;
determining a first security value using the unique characteristic; and
storing the first security value on a second information encoding region.

30. The method of claim 29, wherein the presentation instrument comprises a selection from the group consisting of credit card, debit card, gift card, smart card, RF-enabled card, fob, a negotiable instrument having magnetic ink character recognition-enabled printing, and three-dimensional object.

31. The method of claim 29, wherein the first and second information encoding regions comprise the same region.

32. The method of claim 29, wherein the first and second information encoding regions comprise different regions.

33. The method of claim 29, wherein the first information encoding region comprises a magnetic encoding region and the unique characteristic comprises a magnetic fingerprint.

34. The method of claim 29, wherein the second information encoding region comprises a RF-enabled device.

35. The method of claim 29, wherein the second information encoding region comprises a bar code.

36. The method of claim 29, wherein determining a first security value using the unique characteristic comprises determining an alphanumerical representation of the unique characteristic.

37. The method of claim 29, wherein determining a first security value using the unique characteristic comprises determining a hash value relating to an alphanumerical representation of the unique characteristic.

38. The method of claim 29, wherein determining a first security value using the unique characteristic comprises creating a digital signature using at least an alphanumerical representation of the unique characteristic.

39. The method of claim 29, further comprising:
determining a second security value relating to the unique characteristic of the first information encoding region; and
storing the second security value on the second information encoding region.

40. The method of claim 39, wherein the first information encoding region comprises a magnetic encoding region, the second information encoding region comprises a RF-enabled device, the first security value comprises a magnetic fingerprint of the magnetic encoding region, and the second security value comprises a digital signature produced at least in part from the magnetic fingerprint.

41. The method of claim 29, wherein the first information encoding region comprises a magnetic encoding region, the second information encoding region comprises a bar code, the unique characteristic comprises a magnetic fingerprint, and the first security value comprises an alphanumerical representation of the magnetic fingerprint.
